(19) United States
(12) Patent Application Publication
(10) Pub. No.: US 2012/0091383 A1
(43) Pub. Date: Apr. 19, 2012

(54) Marine Moisture Blocking Valve

(76) Inventor: Edward V. Heedles, Forked River, NJ (US)

(21) Appl. No.: 12/848,191

(22) Filed: Oct. 14, 2010

(51) Int. Cl. F16K 51/00

(52) U.S. Cl. 251/356

(57) ABSTRACT

Presently a recreational boater puts an additive in the fuel tank every time he/she buys gas for their boat. Even with the additives on the market, ambient moisture is absorbed into the fuel tank causing stalls while underway and the buildup of water in the bottom of the fuel tank. The purpose of the marine moisture blocking valve is to prevent ambient moisture from being absorbed by the ethanol additive used in gasoline marine engines use while still allowing the fuel tank to draw air and also allowing for expansion and venting of fuel vapor. Simply put the valve is designed to help prevent marine fuel tanks from absorbing water rendering the fuel in the tank useless.

This substitute specification contains no new matter and is being submitted to include the missing parts in accordance with Confirmation No. 5430 Formalities latter dated Aug. 16, 2010.

The purpose of the marine moisture blocking valve is to prevent ambient moisture from being absorbed by the ethanol in the fuel tank of a gasoline marine engine while still allowing the fuel tank to draw air and also allowing for expansion and venting of fuel vapor. Simply put the valve is designed to help prevent marine fuel tanks from absorbing water rendering the fuel in the tank useless.

### CROSS REFERENCE TO RELATED APPLICATION

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The purpose of the marine moisture blocking valve is to prevent ambient moisture from being absorbed by the ethanol in the fuel tank of a gasoline marine engine while still allowing the fuel tank to draw air and also allowing for expansion and venting of fuel vapor. Simply put the valve is designed to help prevent marine fuel tanks from absorbing water rendering the fuel in the tank useless.

### BRIEF SUMMARY OF THE INVENTION

The marine moisture blocking valve is a bi-directional mechanical device. Its internal components are symmetrical in the upper and lower compartments. It is designed to be installed in-line inside the fuel vent host on a marine gasoline engine. Although additives are used to preserve the fuel used on a boat. The high moisture in the atmosphere of a marine environment is absorbed by the ethanol which has become an additive to all gasoline fuels. The valve seals the fuel from the outside air by means of a spring loaded mechanical valve which opens when the fuel pump draws fuel on one end and opens to allow for the expansion of fuel vapors when the temperature rises on the other end.

### BRIEF DESCRIPTION OF SEVERAL VIEWS OF THE DRAWING

FIG. 1 is an overhead view of the plastic center plate. It shows the two ⅝″ openings by which the air passes through and the 2 plastic spring loaded pistons are seated. The plate is 2″ wide and has a ¼″ space in between the two openings and ¼″ between the outer edge of the opening and the outside edge of the plate.

FIG. 2 is a cross sectional view of the valve showing the spring loaded piston, the center plate, the two openings in the center plate and the two openings at the top and bottom of the valve. Note that the top and bottom of the valve are symmetrical.

FIG. 3 shows the applied use of the valve as installed inline in the fuel tank vent hose.

### DETAILED DESCRIPTION OF THE INVENTION

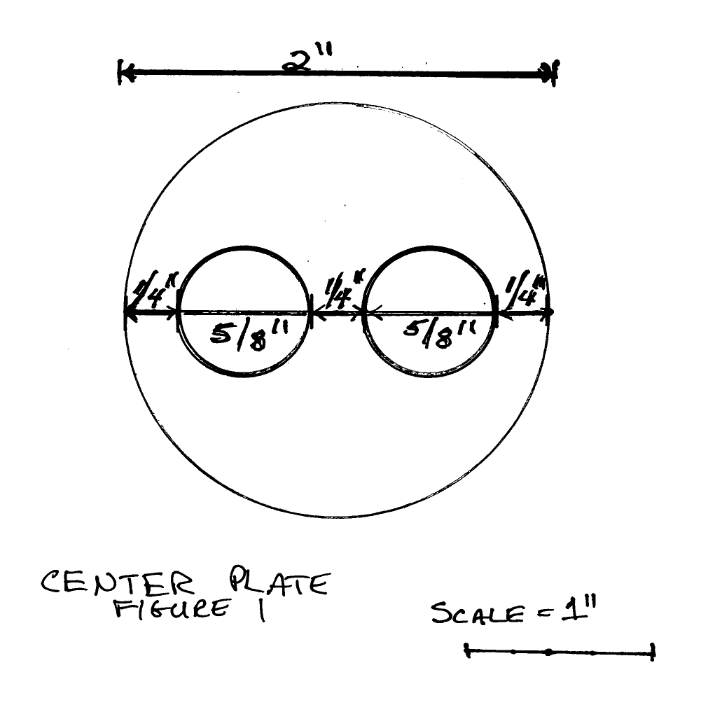

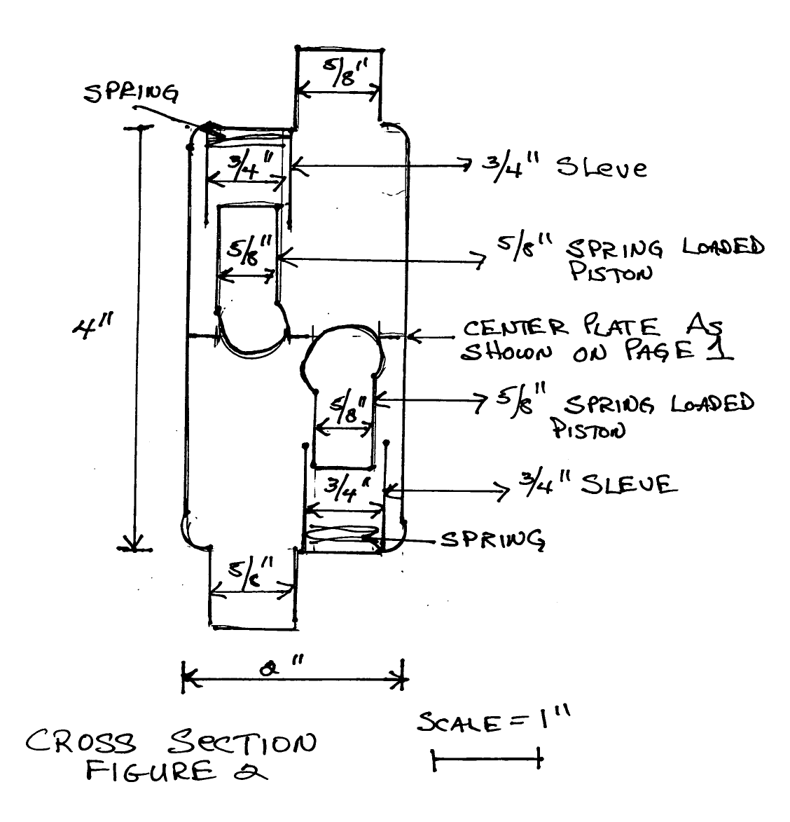

The marine moisture blocking valve is 2 inches wide and 4 inches long. It is made of plastic. Its internal components are symmetrical in the upper and lower compartments. In the center of the valve there is a 2 inch diameter plastic plate with two-⅝″ openings. (FIG. 1). In both the base and top of the unit, there is a ¾″ tube with a spring inside. A ⅝″ piston with a ¾″ ball top goes into the spring loaded tube. The spring holds the ¾″ ball top of the piston tight against the ⅝″ opening in the center plate (FIG. 2).

When the engine draws air the pressure from the fuel pump draws the piston away from the plate to allow air to be drawn into the fuel tank.

After the draw has ended the spring pushes the piston back against the plate blocking the moisture from being drawn into the ethanol in the fuel.

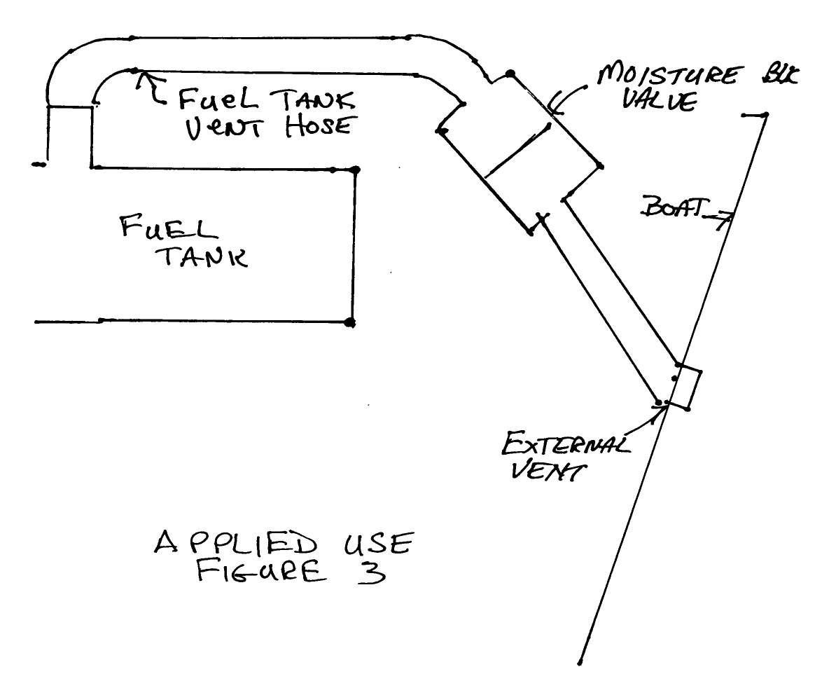

When the vessel is at rest, any vapors expanding in the fuel tank can escape by the valve in the other end of the unit. The pressure exerted by the gas expanding will push the piston down allowing the vapor to escape. In FIG. 2 an exploded view of the unit shows all components. FIG. 3 shows the unit installed.

1. The marine moisture blocking valve is a mechanical device installed within the fuel tank vent hose designed to block the ambient moisture in a marine environment from being absorbed by the ethanol additive in gasoline used in a marine engines while still allowing the fuel tank to draw air and also allowing for expansion and venting of fuel vapor.
